(19) United States
(12) Patent Application Publication
(10) Pub. No.: US 2016/0260156 A1
(43) Pub. Date: Sep. 8, 2016

(54) DATA COMMUNICATION METHOD AND DATA COMMUNICATION SYSTEM

(71) Applicant: KIMREE HI-TECH INC., Tortola (VG)

(72) Inventor: Qiuming Liu, Huizhou (CN)

(21) Appl. No.: 15/158,029

(22) Filed: May 18, 2016

Related U.S. Application Data
(63) Continuation of application No. PCT/CN2014/080306, filed on Jun. 19, 2014.

(51) Int. Cl. G06Q 30/06; G07F 17/32; G06Q 30/02

(52) U.S. Cl. CPC G06Q 30/0631; G06Q 30/0201; G07F 17/3239; A24F 47/002

(57) ABSTRACT

The present disclosure provides a data communication method and a data communication system. The data communication method includes: acquiring, by a user terminal, usage information of an application, wherein the user terminal is bound to a preset electronic cigarette, and the application is provided in the user terminal and is electronic cigarette-related; transmitting, by the user terminal, the acquired usage information to a service platform; and acquiring, by the service platform based on the usage information, a usage frequency of the application by the user terminal. The present invention can provide better products and better services for a variety of electronic cigarette users.

### CROSS-REFERENCES TO RELATED APPLICATIONS

The present application is a continuation of PCT/CN2014/080306, filed on Jun. 19, 2014 and titled “DATA COMMUNICATION METHOD AND DATA COMMUNICATION SYSTEM”, which is incorporated herein by reference in its entirety.

### FIELD

The present invention relates to the field of communication, and in particular to a data communication method and a data communication system.

### BACKGROUND

Electronic cigarettes are a new type of electronic product, similar to normal cigarettes in appearance and taste, but healthier and more environmentally friendly than the traditional cigarettes.

As a growing number of people are using electronic cigarettes, the need for information on a variety of aspects of the electronic cigarette is increasing among users. However, different users have different needs for information on the aspects of the electronic cigarette.

However, in the prior art the information that meets a user's need is unavailable because it is impossible to learn on which aspect of the electronic cigarette the user needs information.

### SUMMARY

The present disclosure provides a data communication method and a data communication system, which can facilitate classification of users, to provide better products and better services for a variety of electronic cigarette users.

A data communication method according to the present disclosure includes:

acquiring, by a user terminal, usage information of an application, wherein the user terminal is bound to a preset electronic cigarette, and the application is provided in the user terminal and is electronic cigarette-related;

transmitting, by the user terminal, the acquired usage information to a service platform; and

acquiring, by the service platform based on the usage information, a usage frequency of the application by the user terminal.

Optionally, the application may include at least a first function module; and

the acquiring, by a user terminal, usage information of an application may include:
acquiring, by the user terminal, a usage identification and a usage time of the first function module of the application.

Optionally, the first function module may be a product module, for exhibiting and selling different electronic cigarette-related products.

Optionally, the acquiring, by the service platform based on the usage information, a usage frequency of the application by the user terminal may include:

acquiring, by the service platform based on the usage information, at least one of: the number of times that the user terminal uses the product module of the application within a preset duration, a usage frequency trend chart, the number of times that each product exhibited by the product module is viewed, and the number of times that each product exhibited by the product module is purchased.

Optionally, the first function module may be a gaming module, including at least one electronic cigarette-related game.

Optionally, the acquiring, by the service platform based on the usage information, a usage frequency of the application by the user terminal may include:

acquiring, by the service platform based on the usage information, the number of times that the user terminal uses each game in the gaming module of the application within a preset duration, a usage frequency trend chart for each game, and a ranking of the games on the total number of times that a game is used.

Optionally, the first function module may be a forum module, including at least one electronic cigarette-related board.

Optionally, the acquiring, by the service platform based on the usage information, a usage frequency of the application by the user terminal may include:

acquiring, by the service platform based on the usage information, at least one of the number of times that the user terminal uses each board in the forum module of the application within a preset duration, a usage frequency trend chart for each board, and a ranking of the boards on the total number of times that a board is used.

Optionally, the first function module may be a vicinity module, for exhibiting information on a physical, electronic cigarette-related store that is not more than a preset distance away from the user terminal.

Optionally, the acquiring, by the service platform based on the usage information, a usage frequency of the application by the user terminal may include:

acquiring, by the service platform based on the usage information, the number of times that the user terminal uses the vicinity module of the application within a preset duration and/or a usage frequency trend chart for the vicinity module.

Optionally, the method may further include:

detecting whether device information and/or system version information of the user terminal is recorded on the service platform, and if not, transmitting, by the user terminal, the device information and/or system version information of the user terminal to the service platform.

Optionally, the acquiring, by a user terminal, usage information of the application by the user terminal may include:

acquiring, by the user terminal, registration information of the application and a time when the user terminal in which the application is registered logs on the application; and

the acquiring, by the service platform based on the usage information, a usage frequency of the application by the user terminal may include:

acquiring, by the service platform, the number of times that the user terminal in which the application is registered logs on the application within a preset duration.

Optionally, the method may further include:

raising, by the service platform based on the usage information, a user score for the user terminal after the user terminal in which the application is registered logs on the application; and

enabling, by the user terminal, a user to enter a lottery with the user score.

Optionally, the user terminal may be a mobile phone, a personal computer, a laptop computer, or a tablet computer.

A data communication system according to an embodiment of the present disclosure includes:

a user terminal and a service platform, wherein

the user terminal is bound to a preset electronic cigarette, and an application that is electronic cigarette-related is provided in the user terminal;

the user terminal is configured to acquire usage information of the application and transmit the acquired usage information to the service platform; and

the service platform is configured to acquire, based on the user information, a usage frequency of the application by the user terminal.

Optionally, the application may include at least a first function module; and

the user terminal may be configured to acquire an identification of the first function module and a usage time of the first function module of the application, and transmit the identification and the usage time to the service platform.

Optionally, the first function module may be a product module, for exhibiting and selling different electronic cigarette-related products; and

the service platform may be configured to acquire, based on the usage information, at least one of: the number of times that the user terminal uses the product module of the application within a preset duration, a usage frequency trend chart, the number of times that each product exhibited by the product module is viewed, and the number of times that each product exhibited by the product module is purchased.

Optionally, the first function module may be a gaming module, including at least one electronic cigarette-related game; and

the service platform may be configured to acquire, based on the usage information, the number of times that the user terminal uses each game in the gaming module of the application within a preset duration, a usage frequency trend chart for each game, and a ranking of the games on the total number of times that a game is used.

Optionally, the first function module may be a forum module, including at least one electronic cigarette-related board; and

the service platform may be configured to acquire, based on the usage information, the number of times that the user terminal uses each board in the forum module of the application within a preset duration, a usage frequency trend chart for each board, and a ranking of the boards on the total number of times that a board is used.

Optionally, the first function may be a vicinity module, for exhibiting information on a physical, electronic cigarette-related store that is not more than a preset distance away from the user terminal; and

the service platform may be configured to acquire, based on the usage information, the number of times that the user terminal uses the vicinity module of the application within a preset duration and/or a usage frequency trend chart for the vicinity module.

It can be seen from the above that the present disclosure has advantages as follows.

In the present disclosure, the user terminal acquires usage information of an application that is electronic cigarette-related, and transmits the acquired usage information to the service platform; thus, the service platform may acquire, based on the usage information, a usage frequency of the electronic cigarette-related application by the user terminal, so that the service platform knows how the user terminal uses the application, facilitating classification of user terminals by the service platform, and further allowing the service platform to provide information meeting respective needs of the user terminals, realizing better products and better services for a variety of electronic cigarette users.

### BRIEF DESCRIPTION OF THE DRAWINGS

The accompanying drawings used in the description of the embodiments and the prior art are described briefly as follows, for a better understanding of the technical solutions according to the embodiments of the present disclosure and the prior art. Clearly, the drawings herein are only some of the embodiments of the present invention. For those skilled in the art, other drawings may be obtained according to these drawings without inventive effort.

FIG. 1 is a flowchart of a data communication method according to an embodiment of the present disclosure;

FIG. 2 is a flowchart of a data communication method according to another embodiment of the present disclosure;

FIG. 3 is a flowchart of a data communication method according to a further embodiment of the present disclosure; and

FIG. 4 is a schematic diagram of a data communication system according to an embodiment of the present disclosure.

### DETAILED DESCRIPTION

The embodiments according to the present disclosure include a data communication method and a data communication system, which can facilitate classification of users, to provide better products and better services for a variety of electronic cigarette users.

The technical solutions according to the embodiments of the present disclosure will be described hereinafter in conjunction with the accompanying drawings. Clearly, the embodiments described herein are only some of the embodiments of the present invention. Any other embodiment obtained by those skilled in the art based on the embodiments described herein without inventive effort shall fall in the scope of the present invention.

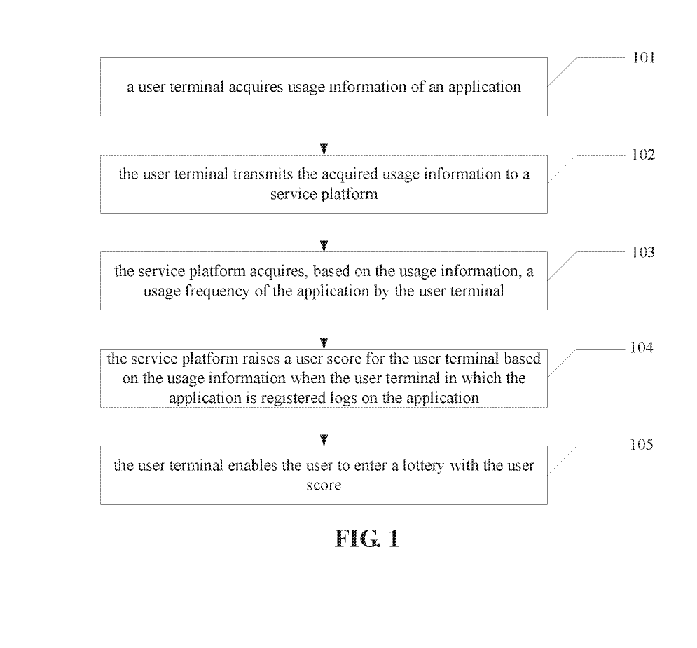

Referring to FIG. 1, an embodiment of a data communication method according to an embodiment of the present disclosure includes the following steps.

In step 101, a user terminal acquires usage information of an application.

In this embodiment, the user terminal may be a mobile phone, a personal computer, a laptop computer, a tablet computer or any other type of terminal. The present disclosure is not limited to any particular type. The user terminal is bound to a preset electronic cigarette, which refers to the user terminal being capable of receiving a signal from the preset electronic cigarette.

An application that is electronic cigarette-related is provided in the user terminal. The application is electronic cigarette-related, which refers to the application exhibiting a content or acting with an object that includes: an electronic cigarette, a component of an electronic cigarette, a product or seller that is electronic cigarette-related, or any other type of information that is electronic cigarette-related.

The usage information of the application may include multiple types of information, such as registration information of the application, a time when a user terminal in which the application is registered logs on the application, or usage identifications or usage times of different function modules of the application. As a matter of course, in practice, the usage information of the application may include any other type of information; the present disclosure is not limited to any particular type.

In step 102, the user terminal transmits the acquired usage information to a service platform.

After acquiring the usage information of the application, the user terminal transmits the usage information to a service platform. Specifically, the user terminal may transmit the usage information to the service platform over a mobile communication network, a WiFi network or any other type of communication network.

In this embodiment, the user terminal is connected to the service platform via a communication network, and one service platform may serve multiple user terminals.

In step 103, the service platform acquires, based on the usage information, a usage frequency of the application by the user terminal.

After receiving the usage information from the user terminal, the service platform performs a statistical analysis on the usage information, to acquire a usage frequency of the application by the user terminal based on the usage information. Specifically, the usage frequency of the application may includes the number of times that the user terminal in which the application is registered logs on the application within a preset duration, or the numbers of times that the user terminal uses respective modules of the application within a preset duration, etc. As a matter of course, the above are only some of the examples of the usage frequency of the application; the present disclosure is not limited to any particular arrangement.

It should be noted that, each user terminal has a unique identification. The service platform stores the identifications of user terminals upon receipt of the usage information from the user terminals, with the identification of a user terminal matching the usage information from the user terminal, so that the service platform distinguishes between the user terminals where the usage information is from.

In this embodiment, by the user terminal acquiring the usage information of the application and transmitting the usage information to the service platform, the service platform may acquire the usage frequency of the application by the user terminal based on the usage information, so that the service platform knows how the user terminal uses the application, facilitating classification of user terminals by the service platform, and further allowing the service platform to provide information meeting respective needs of the user terminals.

Optionally, in this embodiment, the acquiring by a user terminal usage information of the application by the user terminal may include acquiring by the user terminal registration information of the application and a time when the user terminal in which the application is registered logs on the application. And the data communication method according to the embodiment may further include the following steps.

In step 104, the service platform raises a user score for the user terminal based on the usage information when the user terminal in which the application is registered logs on the application.

The service platform may create a user score for each user terminal in which the application is registered. The initial value of the user score may be zero or preset by the service platform. After the user terminal in which the application is registered logs on the application, the service platform raises the user score for the user terminal based on the usage information of the application by the user terminal. It should be noted that, the service platform may raise the user score for only some of the operations by the user terminal on the application; and different operations may correspond to different or the same user scores added. The specific user scores to be added may be preset by the service platform.

In step 105, the user terminal enables the user to enter a lottery with the user score.

The user terminal that has logged on the application exhibits the value of the user score of the user terminal to the user of the user terminal, and the user may enter a lottery with the user score. The service platform may deduct a part of the user score of the user terminal after each draw of the lottery.

In this way, by enabling the user to enter a lottery with the user score, the user may be encouraged to use the application often, so that the service platform collects more usage information of the application by the user terminal, further facilitating classification of user terminals by the service platform.

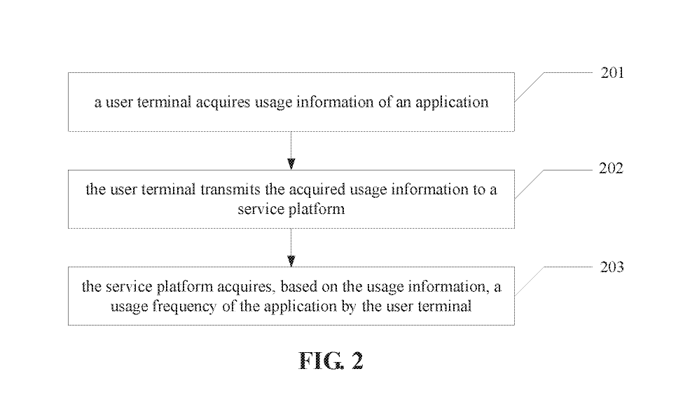

The data communication method according to an embodiment of the present disclosure will be described hereinafter in detail. Referring to FIG. 2, the data communication method according to another embodiment of the present disclosure includes the following steps.

In step 201, a user terminal acquires usage information of an application.

Fore a detailed description, please refers to the description of step 101 in the embodiment illustrated in FIG. 1.

Specifically, in this embodiment, the application includes at least a first function module. It should be noted that, each function module has a unique identification; and the usage information acquired by the user terminal for respective function modules of the application includes the usage identifications of the function modules, so that the usage of a function module can be matched to the function module. The usage information of the application acquired by the user terminal includes a usage identification and a usage time of the first function module.

Optionally, the first function module of the application is a product module, for exhibiting and selling different electronic cigarette-related products. It should be noted that, the electronic cigarette-related products include not only electronic cigarettes, but also components of an electronic cigarette and/or peripheral products to an electronic cigarette. Preferably, in the case that the user terminal acquires usage information of the product module, the usage information may further include browsing identifications, browsing times, purchase identifications and purchase times for respective products exhibited by the product module.

Alternatively, the first function module of the application is a gaming module, including at least one electronic cigarette-related game. The electronic cigarette-related game, including an object exhibited in the game, may include different electronic cigarettes, or the rules of the game is electronic cigarette-related. As a matter of course, the above is only an example and the present disclosure is not limited to any particular arrangement. Preferably, in the case that the user terminal acquires usage information of the gaming module, the usage information may further include usage identifications and usage times of respective games in the gaming module.

Alternatively, the first function module of the application is a forum module, including at least one electronic cigarette-related board. An electronic cigarette-related board may refer to a board holding discussions that contain electronic cigarette-related information, e.g., different brands of electronic cigarettes, usage methods of electronic cigarettes, maintenance methods of electronic cigarettes, etc. Preferably, in the case that the user terminal acquires usage information of the gaming module, the usage information may include usage identifications and usage times of respective boards in the forum module.

Alternatively, the first function module of the application is a vicinity module, for exhibiting information on a physical, electronic cigarette-related store that is not more than a preset distance away from the user terminal. A Global Position System (GPS) may be set on the user terminal, for determining the position of the user terminal. The vicinity module searches for a physical, electronic cigarette-related store within the preset distance based on the position of the user terminal. The physical, electronic cigarette-related store includes a physical store where electronic cigarettes, components of an electronic cigarette or peripheral products of an electronic cigarette are sold, or includes a physical store (such as an experiencing store, an exhibition hall or a museum) where electronic cigarettes, components of an electronic cigarette or peripheral products of an electronic cigarette are exhibited. The preset distance may be set by the user terminal by default or by receiving a user's setting; the present disclosure is not limited to any particular arrangement.

As a matter of course, the application in the user terminal may also include at least two of the above function modules, or may also include some other function modules; the present disclosure is not limited to any particular arrangement.

In step 202, the user terminal transmits the acquired usage information to the service platform.

Fore a detailed description, please refers to the description of step 102 in the embodiment illustrated in FIG. 1.

In step 203, the service platform acquires, based on the usage information, a usage frequency of the application by the user terminal.

Fore a detailed description, please refers to the description of step 103 in the embodiment illustrated in FIG. 1.

Specifically, in the case that the first function module is a product module, the service platform may acquire, based on the usage information, at least one of the number of times that the user terminal uses the product module of the application within a preset duration, a usage frequency trend chart, the number of times that each product exhibited by the product module is viewed, and the number of times that each product exhibited by the product module is purchased. It should be noted that, in the case that the first function module is a product module, the usage frequency of the application by the user terminal acquired by the service platform is not limited to the above examples.

Alternatively, in the case that the first function module is a gaming module, the service platform may acquire, based on the usage information, the number of times that the user terminal uses each game in the gaming module of the application within a preset duration, a usage frequency trend chart for each game, a ranking of the games on the total number of times that a game is used. It should be noted that, in the case that the first function module is a gaming module, the usage frequency of the application by the user terminal acquired by the service platform is not limited to the above examples.

Alternatively, in the case that the first function module is a forum module, the service platform may acquire, based on the usage information, the number of times that the user terminal uses each board in the forum module of the application within a preset duration, a usage frequency trend chart for each board, a ranking of the boards on the total number of times that a board is used. It should be noted that, in the case that the first function module is a forum module, the usage frequency of the application by the user terminal acquired by the service platform is not limited to the above examples.

Alternatively, in the case that the first function module is a vicinity module, the service platform may acquire, based on the usage information, the number of times that the user terminal uses the vicinity module of the application within a preset duration and/or a usage frequency trend chart for the vicinity module. It should be noted that, in the case that the first function module is a vicinity module, the usage frequency of the application by the user terminal acquired by the service platform is not limited to the above examples.

In the above examples, the usage frequency trend chart, may be drawn for a period of one month or quarter with each unit representing one day, or for a period of one day with each unit representing one hour. As a matter of course, the present disclosure is not limited to the above examples. The preset duration in the above examples may be set by the service platform by default or by receiving a user's setting; the present disclosure is not limited to any particular arrangement.

In this embodiment, by the user terminal acquiring the usage information of respective function modules of the application and by the service platform acquiring usage frequencies on different aspects of each function module based on the usage information, analysis by the service platform of the users using the user terminals is facilitated, allowing more accurate knowledge on the needs of the users.

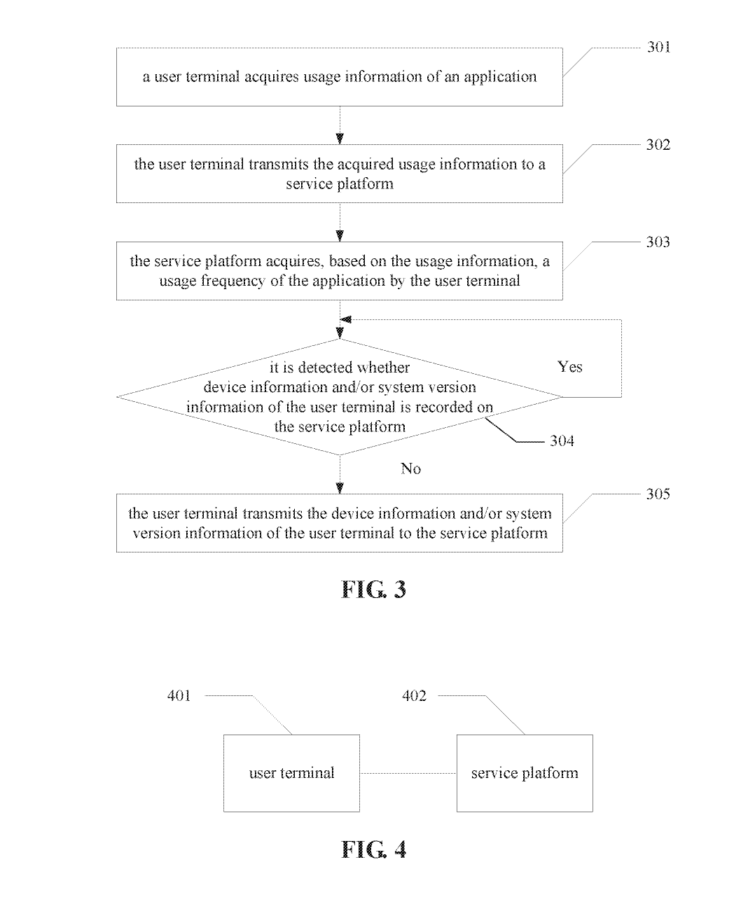

Referring to FIG. 3, a flowchart of a data communication method according to yet another embodiment of the present disclosure, the data communication method according to the embodiment of the present disclosure includes the following steps.

In step 301, a user terminal acquires usage information of an application.

Fore a detailed description, please refers to the description of step 101 in the embodiment illustrated in FIG. 1.

In step 302, the user terminal transmits the acquired usage information to a service platform.

Fore a detailed description, please refers to the description of step 102 in the embodiment illustrated in FIG. 1.

In step 303, the service platform acquires a usage frequency of the application by the user terminal based on the user information.

Fore a detailed description, please refers to the description of step 103 in the embodiment illustrated in FIG. 1.

In step 304, it is detected whether device information and/or system version information of the user terminal is recorded on the service platform, and if not, step 305 is performed.

Multiple approaches may be used for detecting whether device information and/or system version information of the user terminal is recorded on the service platform. For example, t, in which case whether such information is recorded on the service platform may be determined through detecting whether the identification is set in the user terminal. Or, whether such information is recorded on the service platform may be detected through searching for device information and/or system version information of the user terminal in the service platform. As a matter of course, the present disclosure is not limited to the above examples.

In step 305, the user terminal transmits the device information and/or system version information of the user terminal to the service platform.

If it is detected that no device information and/or system version information of the user terminal is recorded on the service platform, the user terminal transmits its device information and/or system version information to the service platform.

In this way, by acquiring device information and/or system version information of the user terminal, more accurate classification of the user terminals by the service platform may be facilitated.

For a better understanding, the data communication method according to an embodiment of the present disclosure will be described in detail below in a more specific application scenario.

In this embodiment, the user terminal may be a mobile phone, a personal computer, a laptop computer, a tablet computer or any other type of terminal. The present disclosure is not limited to any particular type. The user terminal is bound to a preset electronic cigarette, which refers to the user terminal being capable of receiving a signal from the preset electronic cigarette. An application that is electronic cigarette-related is provided in the user terminal. The application is electronic cigarette-related, which refers to the application exhibiting a content or acting with an object that includes: an electronic cigarette, a component of an electronic cigarette, a product or seller that is electronic cigarette-related, or any other type of information that is electronic cigarette-related.

Specifically, the application of the user terminal includes a product module, for exhibiting and selling different electronic cigarette-related products. It should be noted that, the electronic cigarette-related product may include not only electronic cigarettes, but also components of an electronic cigarette and/or peripheral products to an electronic cigarette.

The application of the user terminal further includes a gaming module including at least one electronic cigarette-related game. The electronic cigarette-related game, including an object exhibited in the game, may include different electronic cigarettes, or the rules of the game is electronic cigarette-related.

The application of the user terminal further includes a forum module including at least one electronic cigarette-related board. An electronic cigarette-related board may refer to a board holding discussions that contain electronic cigarette-related information, e.g., different brands of electronic cigarettes, usage methods of electronic cigarettes, maintenance methods of electronic cigarettes, etc.

The application of the user terminal further includes a vicinity module, for exhibiting information on a physical, electronic cigarette-related store that is not more than a preset distance away from the user terminal. A Global Position System (GPS) may be set on the user terminal, for determining the position of the user terminal. The vicinity module searches for a physical, electronic cigarette-related store within the preset distance based on the position of the user terminal. The physical, electronic cigarette-related store includes a physical store where electronic cigarettes, components of an electronic cigarette or peripheral products of an electronic cigarette are sold, or includes a physical store (such as an experiencing store, an exhibition hall or a museum) where electronic cigarettes, components of an electronic cigarette or peripheral products of an electronic cigarette are exhibited. The preset distance may be set by the user terminal by default or by receiving a user's setting; the present disclosure is not limited to any particular arrangement.

The user terminal acquires registration information of the application by the user, a time when the user terminal in which the application is registered logs on the application, and usage identifications and usage times of the four modules, the product module, the gaming module, the forum module and the vicinity module, by the user. Specifically, the user terminal further acquires browsing identifications, browsing times and purchase identifications and purchase times for respective products exhibited by the product module. The user terminal further acquires usage identifications and usage times of respective games in the gaming module, and acquires usage identifications and usage times of respective boards in the forum module.

After acquiring the usage information of the application, the user terminal transmits the usage information to the service platform. Specifically, the user terminal may transmit the usage information to the service platform over a mobile communication network, a WiFi network or any other type of communication network. In this embodiment, the user terminal is connected to the service platform via a communication network, and one service platform may serve multiple user terminals.

After receiving the usage information from the user terminal, the service platform performs a statistical analysis on the usage information, so as to acquire a usage frequency of the application by the user terminal based on the usage information.

The use frequency of the application includes at least one of:

the number of times that the user terminal in which the application is registered logs on the application within a preset duration;

the number of times that the user terminal uses the product module of the application within a preset duration, a usage frequency trend chart, the number of times that each product exhibited by the product module is viewed, and the number of times that each product exhibited by the product module is purchased;

the number of times that the user terminal uses each game in the gaming module of the application within a preset duration, a usage frequency trend chart for each game, and a ranking of the games on the total number of times that a game is used;

the number of times that the user terminal uses each board in the forum module of the application within a preset duration, a usage frequency trend chart for each board, and a ranking of the boards on the total number of times that a board is used; and

the number of times that the user terminal uses the vicinity module of the application within a preset duration and/or a usage frequency trend chart for the vicinity module.

In the above examples, the usage frequency trend chart, may be drawn for a period of one month or quarter with each unit representing one day, or for a period of one day with each unit representing one hour. As a matter of course, the present disclosure is not limited to the above examples. The preset duration in the above examples may be set by the service platform by default or by receiving a user's setting; the present disclosure is not limited to any particular arrangement.

The service platform raises a user score for the user terminal based on the usage information when the user terminal in which the application is registered logs on the application.

Specifically, the service platform may create a user score for each user terminal in which the application is registered. The initial value of the user score may be zero or preset by the service platform. After the user terminal in which the application is registered logs on the application, the service platform raises the user score for the user terminal based on the usage information of the application by the user terminal. It should be noted that, the service platform may raise the user score for only some of the operations by the user terminal on the application; and different operations may correspond to different or the same user scores added. The specific user scores to be added may be preset by the service platform.

The user terminal enables the user to enter a lottery with the user score. Specifically, the user terminal that has logged on the application exhibits the value of the user score of the user terminal to the user of the user terminal, and the user may enter a lottery with the user score. The service platform may deduct a part of the user score of the user terminal after each draw of the lottery.

In addition, the user terminal may set an identification when transmitting device information and/or system version information of the user terminal to the service platform. The user terminal detects whether the identification is set, and if not, the user terminal transmits its device information and/or system version information to the service platform; if so, the user terminal need not transmit the device information and/or system version information to the service platform.

It should be noted that, each user terminal has a unique identification. The service platform stores the identifications of user terminals upon receipt of the usage information from the user terminals, with the identification of a user terminal matching the usage information from the user terminal, so that the service platform distinguishes between the user terminals where the usage information is from.

The data communication method according to an embodiment of the present disclosure is described above. A data communication system will be described below. Referring to FIG. 4, the data communication system according to an embodiment of the present disclosure includes:

a user terminal 401 and a service platform 402, wherein

the user terminal 401 is bound to a preset electronic cigarette and an application that is electronic cigarette-related is provided in the user terminal 401;

the user terminal 401 is configured to acquire usage information of the application and transmit the acquired usage information to the service platform; and

the service platform 402 is configured to acquire, based on the usage information, a usage frequency of the application by the user terminal.

In this embodiment, by the user terminal acquiring the usage information of the application and transmitting the usage information to the service platform, the service platform may acquire the usage frequency of the application by the user terminal based on the usage information, so that the service platform knows how the user terminal uses the application, facilitating classification of user terminals by the service platform, and further allowing the service platform to provide information meeting respective needs of the user terminals.

Preferably, in the embodiment, the application include at least a first function module;

wherein the user terminal 401 is configured to acquire an identification of the first function module and a usage time of the first function module of the application, and transmit the identification and the usage time to the service platform.

Further, preferably, in this embodiment, the first function module is a product module, for exhibiting and selling different electronic cigarette-related products; and

the service platform is configured to acquire, based on the usage information, at least one of: the number of times that the user terminal uses the product module of the application within a preset duration, a usage frequency trend chart, the number of times that each product exhibited by the product module is viewed, and the number of times that each product exhibited by the product module is purchased.

Alternatively, further, preferably, in the embodiment, the first function module is a gaming module, including at least one electronic cigarette-related game; and

the service platform is configured to acquire, based on the usage information, at least one of the number of times that the user terminal uses each game in the gaming module of the application within a preset duration, a usage frequency trend chart for each game, and a ranking of the games on the total number of times that a game is used.

Alternatively, further, preferably, in the embodiment, the first function module is a forum module including at least one electronic cigarette-related board; and

the service platform is configured to acquire, based on the usage information, the number of times that the user terminal uses each board in the forum module of the application within a preset duration, a usage frequency trend chart for each board, and a ranking of the boards on the total number of times that a board is used.

Alternatively, further, preferably, in the embodiment, in the embodiment, the first function is a vicinity module, for exhibiting information on a physical, electronic cigarette-related store that is not more than a preset distance away from the user terminal; and

the service platform is configured to acquire, based on the usage information, the number of times that the user terminal uses the vicinity module of the application within a preset duration and/or a usage frequency trend chart for the vicinity module.

For a better understanding, the data communication system according to an embodiment of the present disclosure will be described in detail below in a more specific application scenario.

In this embodiment, the user terminal 401 may be a mobile phone, a personal computer, a laptop computer, a tablet computer or any other type of terminal. The present disclosure is not limited to any particular type. The user terminal 401 is bound to a preset electronic cigarette, which refers to the user terminal being capable of receiving a signal from the preset electronic cigarette. An application that is electronic cigarette-related is provided in the user terminal 401. The application is electronic cigarette-related, which refers to the application exhibiting a content or acting with an object that includes: an electronic cigarette, a component of an electronic cigarette, a product or seller that is electronic cigarette-related, or any other type of information that is electronic cigarette-related.

Specifically, the application of the user terminal 401 includes a product module, for exhibiting and selling different electronic cigarette-related products. It should be noted that, the electronic cigarette-related product may include not only electronic cigarettes, but also components of an electronic cigarette and/or peripheral products to an electronic cigarette.

The application of the user terminal 401 further includes a gaming module including at least one electronic cigarette-related game. The electronic cigarette-related game, including an object exhibited in the game, may include different electronic cigarettes, or the rules of the game is electronic cigarette-related.

The application of the user terminal 401 further includes a forum module including at least one electronic cigarette-related board. An electronic cigarette-related board may refer to a board holding discussions that contain electronic cigarette-related information, e.g., different brands of electronic cigarettes, usage methods of electronic cigarettes, maintenance methods of electronic cigarettes, etc.

The application of the user terminal 401 further includes a vicinity module, for exhibiting information on a physical, electronic cigarette-related store that is not more than a preset distance away from the user terminal 401. A Global Position System (GPS) may be set on the user terminal, for determining the position of the user terminal 401. The vicinity module searches for a physical, electronic cigarette-related store within the preset distance based on the position of the user terminal. The physical, electronic cigarette-related store includes a physical store where electronic cigarettes, components of an electronic cigarette or peripheral products of an electronic cigarette are sold, or includes a physical store (such as an experiencing store, an exhibition hall or a museum) where electronic cigarettes, components of an electronic cigarette or peripheral products of an electronic cigarette are exhibited. The preset distance may be set by the user terminal by default or by receiving a user's setting; the present disclosure is not limited to any particular arrangement.

The user terminal 401 acquires registration information of the application by the user, a time when the user terminal 401 in which the application is registered logs on the application, and usage identifications and usage times of the four modules, the product module, the gaming module, the forum module and the vicinity module, by the user. Specifically, the user terminal 401 further acquires browsing identifications, browsing times and purchase identifications and purchase times for respective products exhibited by the product module. The user terminal further acquires usage identifications and usage times of respective games in the gaming module, and acquires usage identifications and usage times of respective boards in the forum module.

After acquiring the usage information of the application, the user terminal 401 transmits the usage information to the service platform 402. Specifically, the user terminal 401 may transmit the usage information to the service platform 401 over a mobile communication network, a WiFi network or any other type of communication network. In this embodiment, the user terminal 401 is connected to the service platform 402 via a communication network, and one service platform may serve multiple user terminals.

After receiving the usage information from the user terminal, the service platform 402 performs a statistical analysis on the usage information, so as to acquire a usage frequency of the application by the user terminal based on the usage information.

Specifically, the use frequency of the application includes at least one of:

the number of times that the user terminal in which the application is registered logs on the application within a preset duration;

the number of times that the user terminal uses the product module of the application within a preset duration, a usage frequency trend chart, the number of times that each product exhibited by the product module is viewed, and the number of times that each product exhibited by the product module is purchased;

the number of times that the user terminal uses each game in the gaming module of the application within a preset duration, a usage frequency trend chart for each game, and a ranking of the games on the total number of times that a game is used;

the number of times that the user terminal uses each board in the forum module of the application within a preset duration, a usage frequency trend chart for each board, and a ranking of the boards on the total number of times that a board is used; and

the number of times that the user terminal uses the vicinity module of the application within a preset duration and/or a usage frequency trend chart for the vicinity module.

In the above examples, the usage frequency trend chart, may be drawn for a period of one month or quarter with each unit representing one day, or for a period of one day with each unit representing one hour. As a matter of course, the present disclosure is not limited to the above examples. The preset duration in the above examples may be set by the service platform by default or by receiving a user's setting; the present disclosure is not limited to any particular arrangement.

The service platform 402 raises a user score for the user terminal 401 based on the usage information when the user terminal 401 in which the application is registered logs on the application.

Specifically, the service platform 402 may create a user score for each user terminal 401 in which the application is registered. The initial value of the user score may be zero or preset by the service platform 402. After the user terminal 401 in which the application is registered logs on the application, the service platform 402 raises the user score for the user terminal 401 based on the usage information of the application by the user terminal 401. It should be noted that, the service platform 402 may raise the user score for only some of the operations by the user terminal 401 on the application; and different operations may correspond to different or the same user scores added. The specific user scores to be added may be preset by the service platform 402.

The user terminal 401 enables the user to enter a lottery with the user score. Specifically, the user terminal 401 that has logged on the application exhibits the value of the user score of the user terminal to the user of the user terminal 401, and the user may enter a lottery with the user score. The service platform 402 may deduct a part of the user score of the user terminal after each draw of the lottery.

In addition, the user terminal 401 may set an identification when transmitting device information and/or system version information of the user terminal to the service platform 402. The user terminal 401 detects whether the identification is set, and if not, the user terminal transmits its device information and/or system version information to the service platform; if so, the user terminal need not transmit the device information and/or system version information to the service platform.

It should be noted that, each user terminal 401 has a unique identification. The service platform 402 stores the identifications of user terminals 401 upon receipt of the usage information from the user terminals 401, with the identification of a user terminal 401 matching the usage information from the user terminal 401, so that the service platform distinguishes between the user terminals 401 where the usage information is from.

The embodiments of the present invention are described herein in a progressive manner, with the emphasis of each of the embodiments being the difference between the embodiment and the rest of embodiments; hence, for the same or similar parts between the embodiments, one may refer to the other embodiments.

With the above descriptions of the embodiments disclosed here, the skilled in the art can practice or use the present disclosure. Various modifications to the embodiments may be made by the skilled in the art. The general principle herein can be implemented in other embodiments without departing from the scope of the disclosure. Therefore, the present disclosure shall not be limited to the embodiments disclosed herein, but has the widest scope that is conformity with the principle and novel features disclosed herein.

1. A data communication method, comprising:
acquiring, by a user terminal, usage information of an application, wherein the user terminal is bound to a preset electronic cigarette, and the application is provided in the user terminal and is electronic cigarette-related;
transmitting, by the user terminal, the acquired usage information to a service platform; and
acquiring, by the service platform based on the usage information, a usage frequency of the application by the user terminal.

2. The data communication method according to claim 1, wherein the application comprises at least a first function module; and
the acquiring, by a user terminal, usage information of an application comprises:
acquiring, by the user terminal, a usage identification and a usage time of the first function module of the application.

3. The data communication method according to claim 2, wherein the first function module is a product module, for exhibiting and selling different electronic cigarette-related products.

4. The data communication method according to claim 3, wherein the acquiring, by the service platform based on the usage information, a usage frequency of the application by the user terminal comprises:
acquiring, by the service platform based on the usage information, at least one of: the number of times that the user terminal uses the product module of the application within a preset duration, a usage frequency trend chart, the number of times that each product exhibited by the product module is viewed, and the number of times that each product exhibited by the product module is purchased.

5. The data communication method according to claim 2, wherein the first function module is a gaming module, comprising at least one electronic cigarette-related game.

6. The data communication method according to claim 5, wherein the acquiring, by the service platform based on the usage information, a usage frequency of the application by the user terminal comprises:
acquiring, by the service platform based on the usage information, at least one of the number of times that the user terminal uses each game in the gaming module of the application within a preset duration, a usage frequency trend chart for each game, and a ranking of the games on the total number of times that a game is used.

7. The data communication method according to claim 2, wherein the first function module is a forum module, comprising at least one electronic cigarette-related board.

8. The data communication method according to claim 7, wherein the acquiring, by the service platform based on the usage information, a usage frequency of the application by the user terminal comprises:
acquiring, by the service platform based on the usage information, the number of times that the user terminal uses each board in the forum module of the application within a preset duration, a usage frequency trend chart for each board, and a ranking of the boards on the total number of times that a board is used.

9. The data communication method according to claim 2, wherein the first function module is a vicinity module, for exhibiting information on a physical, electronic cigarette-related store that is not more than a preset distance away from the user terminal.

10. The data communication method according to claim 1, wherein the acquiring, by the service platform based on the usage information, a usage frequency of the application by the user terminal comprises:
acquiring, by the service platform based on the usage information, the number of times that the user terminal uses the vicinity module of the application within a preset duration and/or a usage frequency trend chart for the vicinity module.

11. The data communication method according to claim 1, wherein the method further comprise:
detecting whether device information and/or system version information of the user terminal is recorded on the service platform, and if not, transmitting, by the user terminal, the device information and/or system version information of the user terminal to the service platform.

12. The data communication method according to claim 1, wherein the acquiring, by a user terminal, usage information of the application by the user terminal comprises:
acquiring, by the user terminal, registration information of the application and a time upon the user terminal in which the application is registered logs on the application; and
the acquiring, by the service platform based on the usage information, a usage frequency of the application by the user terminal comprises:
acquiring, by the service platform, the number of times that the user terminal in which the application is registered logs on the application within a preset duration.

13. The data communication method according to claim 12, wherein the method further comprise:
raising, by the service platform based on the usage information, a user score for the user terminal upon the user terminal in which the application is registered logs on the application; and
enabling, by the user terminal, a user to enter a lottery with the user score.

14. The data communication method according to claim 1, wherein the user terminal is a mobile phone, a personal computer, a laptop computer, or a tablet computer.

15. A data communication system, comprising:
a user terminal and a service platform, wherein
the user terminal is bound to a preset electronic cigarette, and an application that is electronic cigarette-related is provided in the user terminal;
the user terminal is configured to acquire usage information of the application and transmit the acquired usage information to the service platform; and
the service platform is configured to acquire, based on the user information, a usage frequency of the application by the user terminal.

16. The data communication system according to claim 15, wherein, the application comprises at least a first function module; and
the user terminal is configured to acquire an identification of the first function module and a usage time of the first function module of the application, and transmit the identification and the usage time to the service platform.

17. The data communication system according to claim 16, wherein the first function module is a product module, for exhibiting and selling different electronic cigarette-related products; and
the service platform is configured to acquire, based on the usage information, at least one of the number of times that the user terminal uses the product module of the application within a preset duration, a usage frequency trend chart, the number of times that each product exhibited by the product module is viewed, and the number of times that each product exhibited by the product module is purchased.

18. The data communication method according to claim 16, wherein the first function module is a gaming module, comprising at least one electronic cigarette-related game; and
the service platform is configured to acquire, based on the usage information, at least one of the number of times that the user terminal uses each game in the gaming module of the application within a preset duration, a usage frequency trend chart for each game, and a ranking of the games on the total number of times that a game is used.

19. The data communication method according to claim 16, wherein the first function module is a forum module, comprising at least one electronic cigarette-related board; and
the service platform is configured to acquire, based on the usage information, at least one of the number of times that the user terminal uses each board in the forum module of the application within a preset duration, a usage frequency trend chart for each board, and a ranking of the boards on the total number of times that a board is used.

20. The data communication method according to claim 16, wherein the first function is a vicinity module, for exhibiting information on a physical, electronic cigarette-related store that is not more than a preset distance away from the user terminal; and
the service platform is configured to acquire, based on the usage information, the number of times that the user terminal uses the vicinity module of the application within a preset duration and/or a usage frequency trend chart for the vicinity module.
